(19) United States
(12) Patent Application Publication
(10) Pub. No.: US 2011/0009232 A1
(43) Pub. Date: Jan. 13, 2011

(54) Planetary gear

(76) Inventor: Alexander Kapelevich, Shoreview, MN (US)

Correspondence Address: Yefim KREYDIN, 201 East 28 Street # 2E, New York, NY, 10016, US

(21) Appl. No.: 12/803,246

(22) Filed: Jun. 22, 2010

Related U.S. Application Data
(60) Provisional application No. 61/224,931, filed on Jul. 13, 2009.

(51) Int. Cl. F16H 57/08

(52) U.S. Cl. 475/331

(57) ABSTRACT

A planetary gear drive comprises two stages. Each of two stages comprises a central sun gear, a crown gear, several satellites located on a carrier between the sun gear and the crown gear, input and output shafts. The sun gear of the first and second stages is rigidly connected to each other. The input shaft is rigidly connected with the sun gear of the first stage. The carriers of the first and the second stages are rigidly connected to each other and, the output shaft is rigidly connected with the crown gear of the second stage (first embodiment). The crown gears of the first and the second stages are rigidly connected to each other, and the output shaft is rigidly connected with the carrier of the second stage (second embodiment).

The satellites are at least at one stage are unevenly distributed around.

This application claims priority from U.S. Provisional Application 61/224,931 filed Jul. 13, 2009, the entire disclosure of which is incorporated herein by reference

### BACKGROUND OF THE INVENTION

1. Field of the Invention

This invention relates to planetary gear, and in particular to planetary gear for applications requiring high gear ratio (the input shaft angular speed divided on the output shaft angular speed) from 100:1 to 100,000:1 and more.

2. Discussion of the Prior Art

It is known in the art examples of planetary gear drives. For example the planetary gears described in U.S. Pat. Nos. 1,632,123 and 1,998,891. An advantage of the planetary gear drive having the configuration described in the above disclosure is that it enables a compact drive configuration. However, it does not have a sufficient high gear ratio (the input shaft angular speed divided on the output shaft angular speed) from 100:1 to 100,000 and more

### SUMMARY OF THE INVENTION

In view of the above drawbacks of the prior art, an object of the present invention is to provide a planetary gear drive that has a sufficient high gear ratio (the input shaft angular speed divided on the output shaft angular speed) from 100:1 to 100,000:1 and more.

To attain this object, the present invention provides a planetary gear drive comprises two stages, each of which comprises a central sun gear, a crown gear, several satellites located on a carrier between the sun gear and the crown gear, input and output shafts wherein the input shaft is rigidly connected with the sun gear of the first stage, the sun gears of the first and second stages are in engagement with the satellites of the first and second stages respectively, the output shaft is rigidly connected with the crown gear of the second stage, and the carriers of the first and second stages rigidly connected to each other (for the first embodiment), the output shaft is rigidly connected with the carrier of the second stage, and the crown gears of the first and second stages are rigidly connected to each other (for the second embodiment),

the crown gears of the first and second stages are in engagement with the satellites of the first and second stages respectively and wherein the sun gear of the first and second stages are rigidly connected to each other.

In another aspect, the invention provides a planetary gear in which (should be with?) two stages, each of which comprises:

a central sun gear, a crown gear, several satellites located on the carrier between the sun gear and the crown gear, input and output shafts

wherein the input shaft is rigidly connected with the sun gear of the first stage,

the output shaft is rigidly connected with the crown gear of the second stage, and the carriers of the first and second stages rigidly connected to each other (for the first embodiment), the sun gears of the first and second stages are in engagement with the satellites of the first and second stages respectively,

the output shaft is rigidly connected with the carrier of the second stage, and the crown gears of the first and second stages are rigidly connected to each other (for the second embodiment), the crown gears of the first and second stages are in engagement with the satellites of the first and second stages respectively and wherein the sun gear of the first and second stages are rigidly connected to each other.

The planetary gear is providing high gear ratio (the input shaft angular speed divided on the output shaft angular speed) from 100:1 to 100,000:1 and more.

It has only two stages. This allows to have low number of gears and other components (shafts, bearings, carriers, etc.). This also reduces number of rubbing surfaces increasing gear efficiency.

The high gear ratio does not depend on number of planets in each stage. This allows selecting more planets per stage to transmit maximum load.

Gear tooth profiles of each stage are designed independently. This allows optimizing gear tooth profiles for minimum specific sliding velocities and maximum efficiency.

The high gear ratio does not require low number of teeth of the sun gears in each stage. This allows selecting more planets per stage to transmit maximum load. This allows reducing specific sliding velocities and increase efficiency.

The foregoing and other objects and advantages of the invention will appear in the detailed description that follows. In the description, reference is made to the accompanying drawings, which illustrate a preferred embodiment of the invention.

### BRIEF DESCRIPTION OF THE DRAWINGS

FIG. 1. Cross Section of the first embodiment of the present invention

FIG. 2. Section II-II FIG. 1

FIG. 3. Section FIG. 1

FIG. 4. Cross Section of the second embodiment of the present invention

FIG. 5. Section V-V FIG. 4

FIG. 6. Section VI-VI FIG. 4

FIG. 7. Schematic arrangement of the first embodiment of the present invention

FIG. 8. Schematic arrangement of the first embodiment of the present invention

### DETAILED DESCRIPTION OF THE PREFERRED EMBODIMENT

On the all Figs: 1- input shaft; 2- first stage sun gear with number of teeth n^{I}₁; 3-second stage sun gear with number of teeth n^{II}₁; 4- carrier; 7- first stage planet gears; 8- second stage planet gears; 11- first stage crown gear with number of teeth n^{I}₃; 12- gear housing; 13- second stage crown gear with number of teeth n^{II}₃; 14- gear housing cap; 15,16- output shaft bearing; 17-output shaft.

### First Embodiment

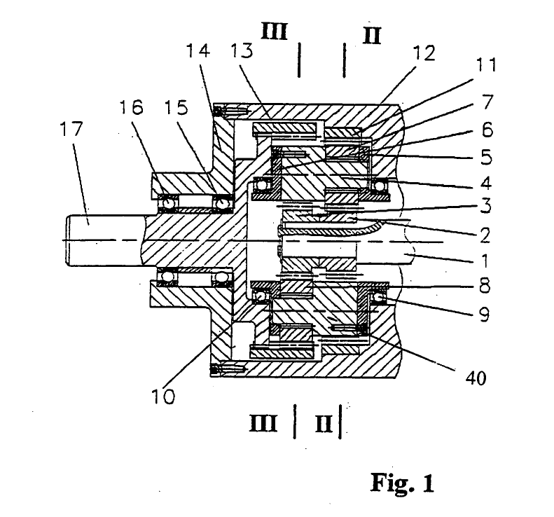

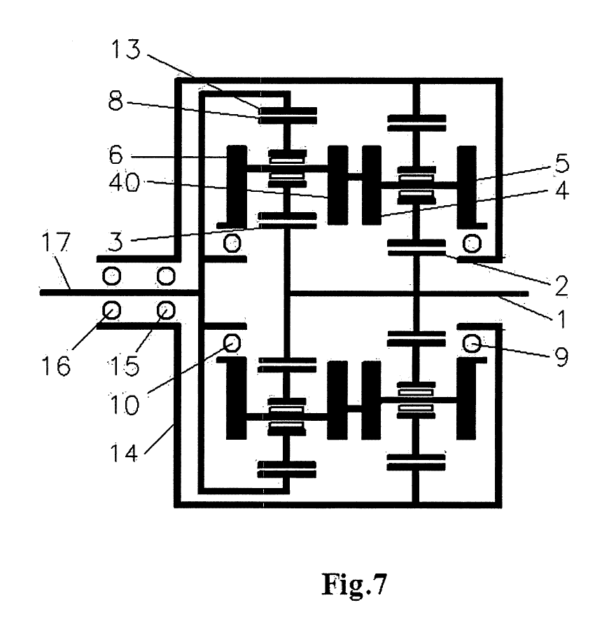

### FIGS. 1-3, 7

The first and second stage sun gears 2 and 3 are rigidly connected to the input shaft 1. The first stage sun gear 2 is engaged with the first stage planet gears 7. The first stage planet gears 7 are rotating on the bearings or bushings on the shafts that are rigidly connected or made as one piece with the carrier 4. The first stage planet gears 7 are constrained in axial direction by the back carrier flange 5, which is rigidly connected to the carrier 4. The back carrier bearing 9 that is pressed into to the gear housing 12 supports the back carrier flange 5. The first stage planet gears 7 are engaged with the first stage crown gear 11. The first stage crown gear 11 is unmovable and rigidly connected to the gear housing 12. The second stage sun gear 3 is engaged with the second stage planet gears 8. The second stage planet gears 8 are rotating on the bearings or bushings on the shafts that are rigidly connected or made as one piece with the carrier 40. The second stage planet gears 8 are constrained in axial direction by the front carrier flange 6, which is rigidly connected to the carrier 40. The front carrier bearing 10 that is pressed in to the output shaft 16 supports the front carrier flange 6. The second stage planet gears 8 are engaged with the second stage crown gear 13. The second stage crown gear 13 is movable and rigidly connected to the output shaft 16. The first stage carrier 4 and the second stage carrier 40 are rigidly connected or made as one piece.

The input shaft 1 transmits rotation by the first stage sun gear 2 to the first stage planet gears 7 that are also engaged with the unmovable first stage crown gear 11. This created the planetary motion of the first stage planet gears 7 and transmits rotation to the first stage carrier 4. The input shaft 1 also transmits rotation by the second stage sun gear 3 to the second stage planet gears 8 that are also engaged with the movable second stage crown gear 13. The second stage planet gears 8 are also involved in planetary motion, because the second stage carrier 40 moves them also. Combination of rotation of the second stage planet gears 8 and their planetary motion creates rotation of the movable second stage crown gear 13 that transmits it to the output shaft 16.

Angular speed difference of the input shaft 1 and the output shaft 16 is defined by gear ratio

$$u = \frac{{n}_{3}^{II} \times ( {n}_{1}^{I} + {n}_{3}^{I} )}{{n}_{1}^{I} \times {n}_{3}^{II} - {n}_{1}^{II} \times {n}_{3}^{I}} \qquad ( 1 )$$

Where

n^{I}₁- number of teeth of the first stage sun gear 2;

n^{II}₁- number of teeth of the second stage sun gear 3;

n^{I}₃- number of teeth of the first stage crown gear 11;

n^{II}₃- number of teeth of the second stage crown gear 13.

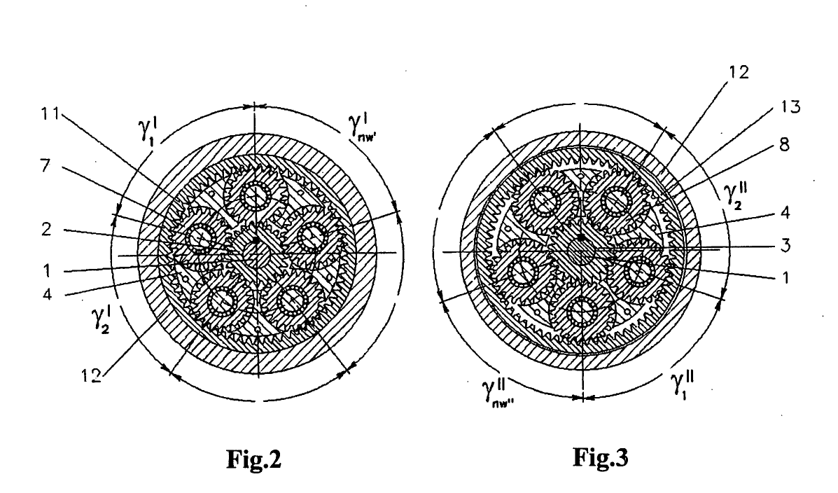

Angles γ^{I}₁, γ^{I}₂, . . . , γ^{I}_{nw} are the central angles of the first stage planet gears' locations (FIG. 2), where nw^{I} is number of planets in the first stage. Angles γ^{II}₁, γ^{II}₂, . . . , γ^{II}_{nw} are the central angles of the second stage planet gears' locations (FIG. 3), where nw^{II} is number of planets in the second stage. The planet gears in one or both stages have uneven angular positions. This means that the central angles in one or both stages are not equal to each other. This uneven planet gear angular position provides proper gear tooth engagement (without interference) for any selected combination of number of teeth. If these central angles are not equal to each other, the carrier assembly is not balanced and the balance holes are drilled in the back and front carrier flanges 5 and 6.

### Second Embodiment

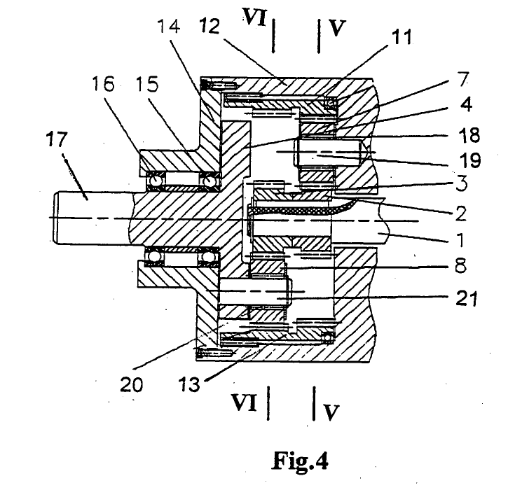

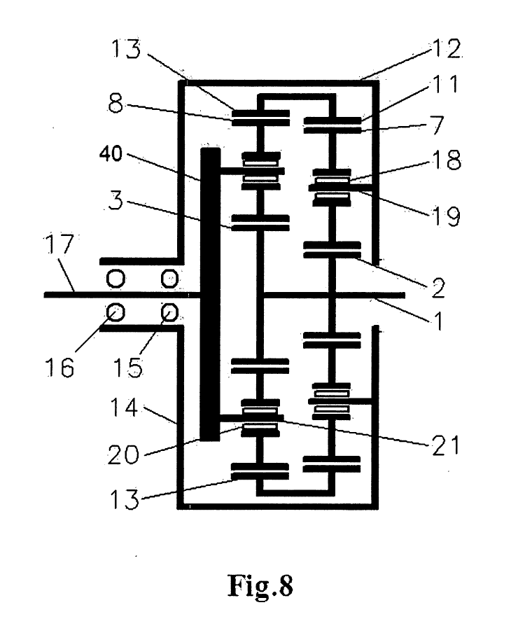

### FIGS. 4-6, 8

The first and second stage sun gears 2 and 3 are rigidly connected to the input shaft 1. The first stage sun gear 2 is engaged with the first stage planet gears 7. The first stage planet gears 7 are rotating on the bearings 18 on the shafts 19 that are rigidly connected (pressed in) or made as one piece with the carrier 4. The first stage planet gears 7 are engaged with the first stage of the crown gear 11. The second stage sun gear 3 is engaged with the second stage planet gears 8. The second stage planet gears 8 are rotating on the bearings 20 on the shafts 21 that are rigidly connected (pressed in) or made as one piece with the carrier 40 that is rigidly connected or made as one piece with the output shaft 17. The second stage planet gears 8 are engaged with the crown gear 13 of the second stage. The first stage of the crown gear 11 and the second stage of the crown gear 13 are rigidly connected or made as one piece.

The input shaft 1 transmits rotation by the first stage sun gear 2 to the first stage planet gears 7 and then to the first stage of the crown gear 11. The input shaft 1 also transmits rotation by the second stage sun gear 3 to the second stage planet gears 8 that are also engaged with the second stage of the crown gear 13. The second stage planet gears 8 are also involved in planetary motion. Combination of rotation of the second stage planet gears 8 and their planetary motion creates rotation of the carrier 4 that that is rigidly connected or made as one piece with the output shaft 17.

Angular speed difference of the input shaft 1 and the output shaft 6 is defined by gear ratio

$$u = \frac{{n}_{3}^{I} \times ( {n}_{1}^{II} + {n}_{3}^{II} )}{{n}_{1}^{II} \times {n}_{3}^{I} - {n}_{1}^{I} \times {n}_{3}^{II}} \qquad ( 2 )$$

Where

n^{I}₁- number of teeth of the first stage sun gear 2;

n^{II}₁- number of teeth of the second stage sun gear 3;

n^{I}₃- number of teeth of the first stage crown gear 11;

n^{II}₃- number of teeth of the second stage crown gear 13.

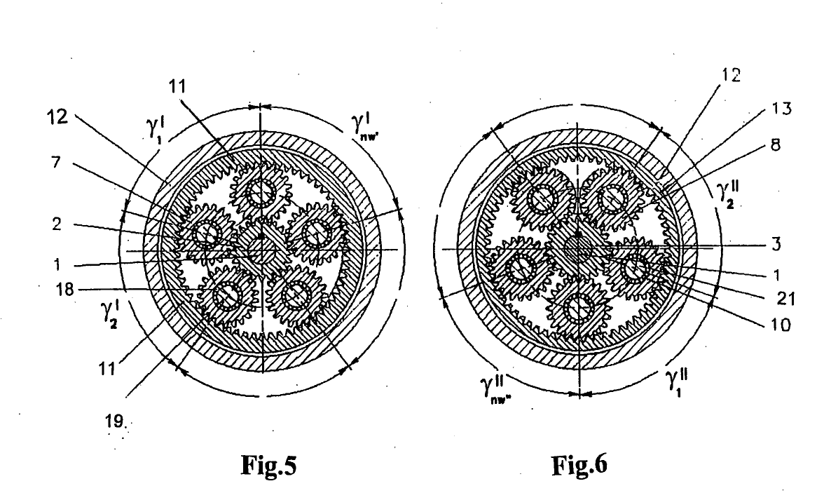

Angles γ^{I}₁, γ^{I}₂, . . . , γ^{I}_{nw} are the central angles of the first stage planet gears' locations (FIG. 5), where nw^{I} is number of planets in the first stage. Angles γ^{II}₁, γ^{II}₂, . . . , γ^{II}_{nw} are the central angles of the second stage planet gears' locations (FIG. 6), where nw^{II} is number of planets in the second stage. The planet gears in one or both stages have uneven angular positions. This means that the central angles in one or both stages are not equal to each other. This uneven planet gear angular position provides proper gear tooth engagement (without interference) for any selected combination of number of teeth. If these central angles of the second stage are not equal to each other, the carrier 40 is not balanced and the balance holes are drilled in the carrier 40.
It is clear from gear ratio (1) and (2) that its denominators differ only in sign.
To achieve maximum transfer of the absolute values of these ratio denominators must be a small integer that is not zero, say 1 or 2.
To ensure these values, the angular positions of the planet gears of one or both stages must be uneven. As well-known two-stage planetary gears, as a rule, have a uneven angular position of the planet gears.
The uneven angular position of the planet gears in one or both stages is the distinctive feature of the present invention.
Thus, the combination of these two distinctive features—connection the elements of a two-stage planetary gear stages and uneven angular positions of the planets in one or both stages are the novelty of present invention, which provides the goal: maximizing the gear ratio in a simple two-stage planetary gear.

All gears can be spur or helical. They can have involute or non-involute tooth profiles. They can have symmetric or asymmetric tooth flank profiles.
The maximum gear ratio depends on the maximum crown gear number of teeth. For most mechanical gear shaping machines it is 400, for the CNC (Computer Numerical Control) machines it is 999.
Then

| Crown gear number of teeth | Maximum gear ratio* |
|---|---|
| 999 | ±1,850,000:1 |
| 400 | ±280,000:1 |
| 300 | ±160,000:1 |
| 200 | ±66,000:1 |
| 100 | ±14,000:1 |

*sign “+”, if rotation directions of the input and output shafts are the same; sign “−”, if rotation directions of the input and output shafts are opposite.

1. A planetary gear comprising two stages, each of which comprises
a central sun gear, a crown gear, several satellites in between the central sun gear and the crown gear, located on a carrier, input and output shafts
wherein the sun gears of the first and second stages are rigidly connected to each other and rigidly connected to the input shaft.

2. The planetary gear according to the claim 1 wherein the satellites are at least at one stage are unevenly distributed around.

3. The planetary gear according to the claim 1 wherein the carriers of the first and second stages are made as one piece or rigidly connected to each other.

4. The planetary gear according to the claim 1 wherein the crown gears of the first and second stages are made as one piece or rigidly connected to each other.

5. The planetary gear according to the claim 3 wherein the output shaft is rigidly connected or made as one piece with the crown gear of the second stage.

6. The planetary gear according to the claim 4 wherein the output shaft is rigidly connected or made as one piece with the carrier of the second stage.

7. The planetary gear according to the claim 1 wherein the sun gears of the first and second stages are in engagement with the satellites of the first and second stages respectively.

8. The planetary gear according to the claim 1 wherein the crown gears of the first and second stages are in engagement with the satellites of the first and second stages respectively.

9. A planetary gear comprising
two stages, each of which comprises
a central sun gear, a crown gear, several satellites located on a carrier between the sun gear and the crown gear, input and output shafts
wherein the input shaft is rigidly connected with the sun gear of the first stage, the carriers of the first and second stages are made as one piece or rigidly connected to each other,
the output shaft is rigidly connected with the crown gear of the second stage,
the sun gears of the first and second stages are in engagement with the satellites of the first and second stages respectively, the output shaft is made as one piece or rigidly connected with the crown gear of the second stage, the crown gears of the first and second stages are in engagement with the satellites of the first and second stages respectively and wherein the sun gears of the first and second stages are rigidly connected to each other and rigidly connected to the input shaft.

10. The planetary gear according to the claim 9 wherein the satellites are at least at one stage are unevenly distributed around.

11. A planetary gear comprising
two stages, each of which comprises
a central sun gear, a crown gear, several satellites located on a carrier between the sun gear and the crown gear, input and output shafts
wherein the input shaft is rigidly connected with the sun gear of the first stage,
the output shaft is made as one piece or rigidly connected with the carrier of the second stage,
the sun gears of the first and second stages are in engagement with the satellites of the first and second stages respectively, the crown gears of the first and second stages are made as one piece or rigidly connected to each other, the crown gears of the first and second stages are in engagement with the satellites of the first and second stages respectively and wherein the sun gears of the first and second stages are rigidly connected to each other and rigidly connected to the input shaft.

12. The planetary gear according to the claim 11 wherein the satellites are at least at one stage are unevenly distributed around.
